(19) United States
(12) Patent Application Publication
(10) Pub. No.: US 2008/0075240 A1
(43) Pub. Date: Mar. 27, 2008

(54) Consultative call transfer using non-voice consultation modes

(75) Inventors: Rajesh Ramanathan, Redmond, WA (US); Eran Shtiegman, Redmond, WA (US); Craig Combel, Issaquah, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/516,397

(22) Filed: Sep. 6, 2006

(51) Int. Cl. H04M 1/64

(52) U.S. Cl. 379/88.12

(57) ABSTRACT

Consultation architecture that allows a call assistant to use modes of consultation with the call recipient other than voice calls or vocal contact. The receptionist can place the incoming call (or message) on hold and send an instant message (IM) to the call recipient that informs the recipient about the call and/or who is calling. The recipient can then acknowledge and respond via the IM or another mode, and agree to accept the call, refuse the call, or request the call be routed to another destination, for example. Other non-voice consultation modes include paging technology by sending a short page to the call recipient, sending an SMS (short message service) or MMS (multimedia messaging service) message to the call recipient, and/or sending an e-mail message to the call recipient that provides information about the call and/or the caller.

### BACKGROUND

Traditional consultative transfer models in telephony systems have relied on the use of the medium of voice for consultation. A typical consulting model is at a doctor's office where all calls for a doctor are picked up by a receptionist. The receptionist places the caller on hold, and then initiates a consultation mode with the doctor by calling and asking if the doctor wants to receive the call. If the doctor chooses to receive the call, the receptionist then transfers the call to the doctor.

While this traditional consultation model may have been adequate in the old world of pre-multimodal messaging technology (e.g., e-mail, instant messaging, paging), its functionality is now becoming an impediment to achieving an efficient and more productive office environment. For example, the traditional model is an inherently interruptive experience-the receptionist has to attempt contact with the doctor using voice communications (whether electronically or face-to-face) before the transfer will be made or the call routed to another destination. Additionally, the doctor's phone has to ring or provide some other type of notification (e.g., a blinking light), the doctor has to be able to perceive the notifications or alerts (e.g., audio signal, blinking light), and the doctor has to answer the call. The doctor usually has no idea what the call is about or who the caller is until s/he picks up the call and talks to the caller. Finally, the traditional model is limiting in the number of consultations that can be happening concurrently. Since the doctor can only be involved with one call connection at a time, the receptionist has to wait for the doctor to either complete the current call or put the call on hold for the consultation to complete, and before another call can be transferred.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The disclosed consultation architecture employs computer-based telephony, for example, to solve problems associated with the traditional consulting model by allowing the receptionist (or call assistant) to use modes of consultation with the call recipient other than voice calls or vocal contact before deciding to transfer the call. For example, the receptionist can place the incoming call on hold and send an instant message (IM) to the call recipient that informs the recipient about the call and/or who is calling. The recipient can then acknowledge and respond via IM, and agree to accept the call, refuse the call, or request that the call be routed to another destination (e.g., voice mail, a different call recipient, IP-based communications device).

Another consultation mode includes the utilization of paging technology by sending a page to the call recipient that provides information about the call and/or the caller. The recipient can then acknowledge the page with a page response (e.g., accept call, refuse call, reroute call) or by other means.

Yet another consultation mode includes sending an SMS (short message service) or MMS (multimedia messaging service) message to the call recipient that provides information about the call and/or the caller. The recipient can then acknowledge the SMS (or MMS) message and respond by agreeing (or refusing) to accept the call, or request that the call be rerouted to another destination.

Still another consultation mode includes sending an e-mail message to the call recipient that provides information about the call and/or the caller. The recipient can then respond to the e-mail by agreeing (or refusing) to accept the call, or request that the call be rerouted to another destination. Once the receptionist receives an IM or an e-mail response, for example, s/he can perform the transfer very quickly (e.g., within a few key strokes).

In support thereof, the architecture disclosed and claimed herein comprises a computer-implemented system that facilitates call management. The system includes a call component for receiving a telephone call for a call recipient, and a notification component that facilitates consulting with the call recipient about the call via a non-voice consultation mode. Notification can be via a SIP-based system and associated SIP-capable devices, for example. A user interface component such as associated with a computer-based telephony application facilitates management of non-voice consultation modes.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a computer-implemented system that facilitates call management.

FIG. 2 illustrates a methodology of managing telephone call communications.

FIG. 3 illustrates a more detailed methodology of managing call transfer by a consultation mode of instant messaging.

FIG. 4 illustrates a more detailed methodology of managing call transfer by a consultation mode of e-mail.

FIG. 5 illustrates a more detailed methodology of managing call transfer by a consultation mode of a messaging service such as SMS.

FIG. 6 illustrates a more detailed methodology of managing call transfer by a consultation mode such as a paging service.

FIG. 7 illustrates an alternative consultation system that utilizes authentication and/or translation for communications processing.

FIG. 8 illustrates an exemplary call flow diagram of an IM exchange as a consultation mode between the assistant and the recipient.

FIG. 9 illustrates an alternative implementation of a message assistant system that facilitates handling of not only incoming telephone calls but also messages of different types for consultation mode for multiple recipients and message management in accordance with the disclosed innovation.

FIG. 10 illustrates a methodology of managing disparate types of incoming messages for a recipient.

FIG. 11 illustrates that data and signals can be passed between a recipient device and a call assistant for determining the best consultation mode to use at a given time.

FIG. 12 illustrates a block diagram of a computing system operable to execute the disclosed consultation architecture.

FIG. 13 illustrates a schematic block diagram of an exemplary computing environment that facilitates call and message consultation in accordance with the disclosed consultation architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

The disclosed innovation provides a more effective and efficient consultation mechanism for handling call and/or messaging communications by allowing the call assistant to use non-voice modes of consultation with the call recipient for determining how to handle the call.

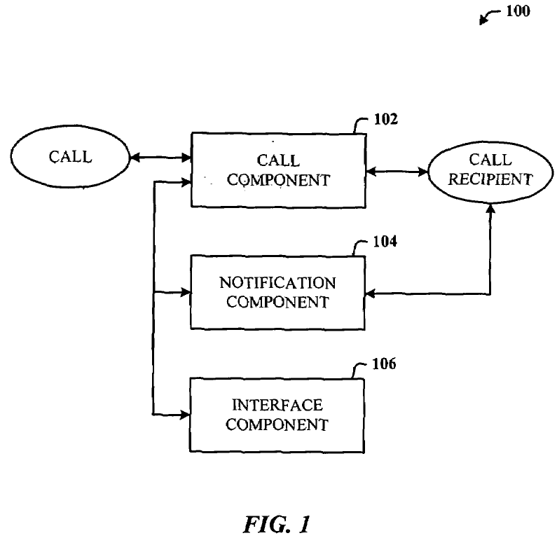

Referring initially to the drawings, FIG. 1 illustrates a computer-implemented system 100 that facilitates call management. The system 100 includes a call component 102 for receiving a telephone call for a call recipient, and a notification component 104 that facilitates consulting with the call recipient about the call via a non-voice consultation mode. Notification can be via a SIP (session initiation protocol) system and associated SIP-capable devices.

A user interface component 106 such as associated with a computer-based telephony application can facilitate management of voice as well as non-voice consultation modes for many different users. In other words, a user (or call recipient) can employ many different types of devices (e.g., cell phone, wired/wireless portable and desktop computers, PDAs and tablet PCs) each having associated device capabilities that can be employed for non-voice consultation during call (or message) processing and handling. Capabilities can include cellular communications, VoIP (voice-over-IP), text messaging, e-mail, instant messaging (IM), messaging services such as SMS (short message service) and/or MMS (multimedia messaging service) and other communications technologies associated with terrestrial and/or satellite cellular and IP-based communications.

Management can include configuring the consultation mode(s) for the call recipient, who can be an employee of an organization, for example. An administrator (e.g., a call assistant person) can administer the consultation modes by entering the mode information of each employee recipient that would be associated with devices the user normally could employ, and devices provided by the employer. Management can also include entering user preferences based on which non-voice consultation mode to use for a given user, user location, time of day, language, identity of the caller, content of the call, and so on. Many other criteria can be employed, if desired, such as gender data, predicted duration of the call, model and capabilities of the associated devices such as legacy device versus newer device, presentation capabilities (e.g., audio, display), alerting capabilities, storage, memory, and processing capabilities, for example.

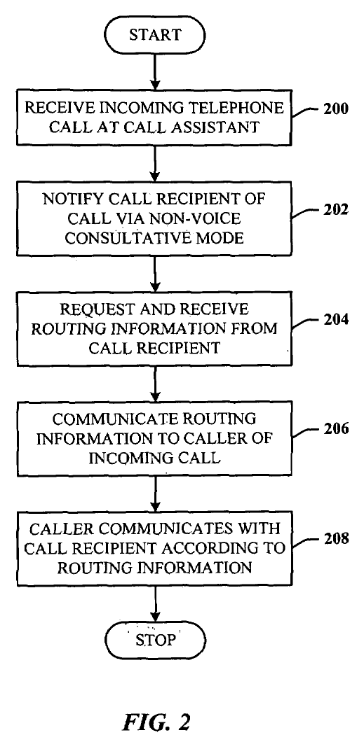

FIG. 2 illustrates a methodology of managing telephone call communications. While, for purposes of simplicity of explanation, the one or more methodologies shown herein, for example, in the form of a flow chart or flow diagram, are shown and described as a series of acts, it is to be understood and appreciated that the subject innovation is not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the innovation.

At 200, an incoming telephone call (e.g., circuit-switched, VoIP, cellular) for a call recipient is received by a call assistant system. At 202, the receptionist (or user) controls the assistant to place the call on hold and notifies (or consults with) the call recipient via a non-voice consultation mode such as IM, SMS, MMS, e-mail and/or a page. This is particularly useful when the call recipient is currently on another call. Thus, the user can communicate information about the call to the recipient without waiting for the recipient to end the current call. This also facilitates the recipient receiving information about another caller without having to end the current call.

At 204, the user requests and receiving routing information from the call recipient via the non-voice consultation mode. The routing information can include signaling (e.g., via a text message) the user to keep the caller on hold until the current call ends, refusing the call, or requesting the user to route the call to another destination such as voice mail or another recipient, for example. This can also include the call recipient requesting that the user communicate with the caller to using another mode of communications such as SMS, MMS, e-mail, or IM, rather than a telephone call, for example. At 206, the recipient conveys the routing information to the user. At 208, the user communicates the routing information to the caller, and the caller communicates with the call recipient according to the routing information.

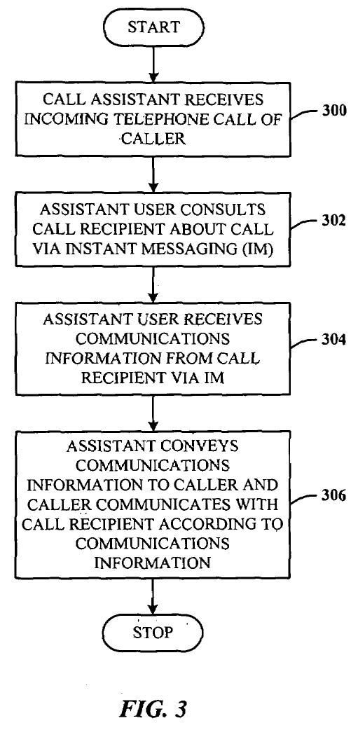

FIG. 3 illustrates a more detailed methodology of managing call transfer by a consultation mode of instant messaging. At 300, the call assistant receives a telephone call from a caller. At 302, the assistant user consults with the call recipient via instant messaging (IM). At 304, the assistant user receives communications information via IM from the recipient related to how the call recipient desires to communicate with the caller. At 306, the assistant user conveys the communications information to the caller and, the call recipient and caller communicate according to the communications information.

The communications information can include instructions to the caller to place a telephone call to the same destination at a later time when the recipient is available. The information can also include communicating via IM and/or e-mail, or by other technologies at this time, for example, or a later time. In other words, given that the recipient can utilize a call headset or other hands-free equipment that allows his/her hands to be free during an existing call, it is within contemplation of the innovation that more adept users can converse on a voice call with one party while consulting with the assistant user or even communicating with a second party via another communications technology (e.g., e-mail, IM, SMS, MMS)

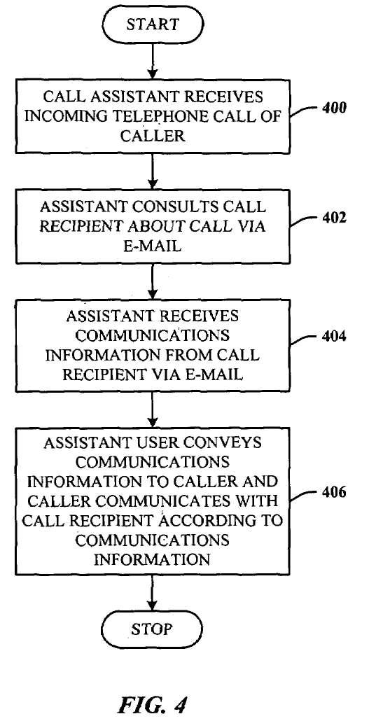

FIG. 4 illustrates a more detailed methodology of managing call transfer by a consultation mode of e-mail. At 400, the call assistant receives a telephone call from a caller. At 402, the assistant user consults with the call recipient via e-mail. At 404, the assistant user receives communications information via e-mail from the recipient related to how the call recipient desires to communicate with the caller. At 406, the assistant user conveys the communications information to the caller and, the call recipient and caller communicate according to the communications information.

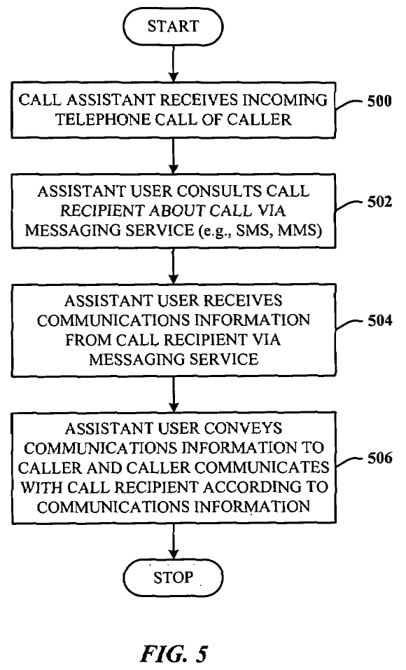

FIG. 5 illustrates a more detailed methodology of managing call transfer by a consultation mode of a messaging service such as SMS. At 500, the call assistant receives a telephone call from a caller. At 502, the assistant user initiates an SMS session (or and MMS session) with the recipient to consult about the incoming call. At 504, the assistant user receives communications information from the recipient via the messaging session related to how the call recipient desires to communicate with the caller. At 506, the assistant user conveys the communications information to the caller and, the call recipient and caller communicate according to the communications information.

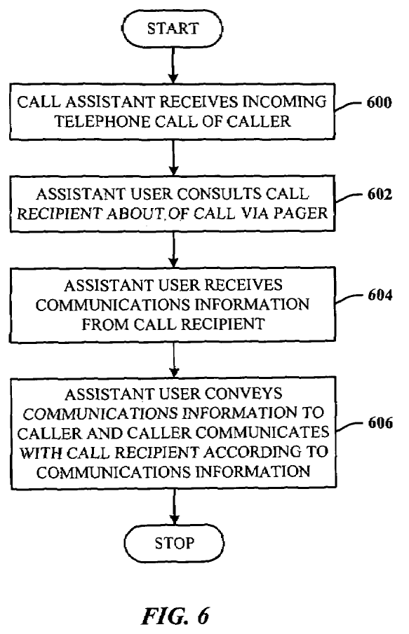

FIG. 6 illustrates a more detailed methodology of managing call transfer by a consultation mode such as a paging service. At 600, the call assistant receives a telephone call from a caller. At 602, the assistant user pages the recipient to consult about the incoming call. At 604, the assistant user receives communications information from the recipient related to how the call recipient desires to communicate with the caller. In a one-way paging system, the assistant can consult with the recipient by paging the recipient to call back with instructions. The recipient can also respond back using a different technology such as e-mail, SMS, MMS, and IM, for example. In a more robust paging system, the recipient can respond to the page over the same channel or similar paging channel using information recognized by the assistant user that represents the desired communications information for caller/recipient communications. At 606, the assistant user then conveys the communications information to the caller and, the call recipient and caller communicate according to the communications information.

In another implementation of the consultative call transfer architecture, the receptionist/admin can provide additional caller information to the recipient about the caller via non-voice modes (e.g., e-mail, SMS, MMS, . . . ). For example, the receptionist/admin can pass additional detailed information about the caller such as an image of the caller, biographical information, business card data, a short audio or video file clip that can be presented, hyperlink to a file associated with the caller, etc., and such information can be displayed via the consultation mode (e.g., e-mail or MMS device) before the recipient decides to accept or reject the call or communication.

Employed separately or in combination with the above preliminary caller information, the recipient can browse or retrieve additional information about the caller from available data sources (e.g., websites, local databases, remote data sources) before accepting or rejecting the call. For example, if the receptionist sends a text message with the caller name and phone number, and the recipient believes the phone number does not match the caller, the recipient can browse a website to perform a reverse phone number lookup to check the caller name against the provided phone number.

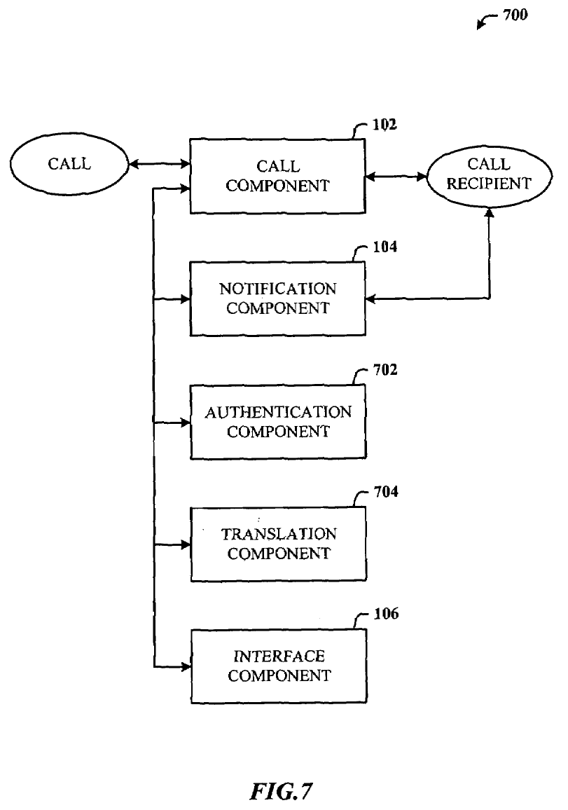

FIG. 7 illustrates an alternative consultation system 700 that utilizes authentication and/or translation for communications processing. The system 700 can include the call component 102, notification component 104, and interface component 106 of FIG. 1. Additionally, an authentication component 702 can be provided for performing authentication of the caller before the assistant user has to intervene (e.g., receive the call). For example, if by analyzing identification (ID) information of the incoming call, authentication processing of the ID information indicates that the caller is undesirable or not to be answered, the call can be dropped without any further processing. If authentication processing indicates the caller is recognized and a preferred caller, authentication passes, and the call can be processed. This can include queuing the call on a first come-first served basis, or even advancing the caller up the queue based on priority criteria.

Authentication can further include processing related to network AAA (authentication, authorization and accounting) services used for network management and security (e.g., for VoIP services) that controls access to computer resources by identifying users, authorizing a level of services and tracking resource usage.

Optionally, the system 700 can also include a translation component 704 such that after consulting with the recipient, the incoming voice call can be converted and translated into text for communication to the recipient as text, if desired. In return, text provided by the recipient can be converted back into audio signals for perception by the caller.

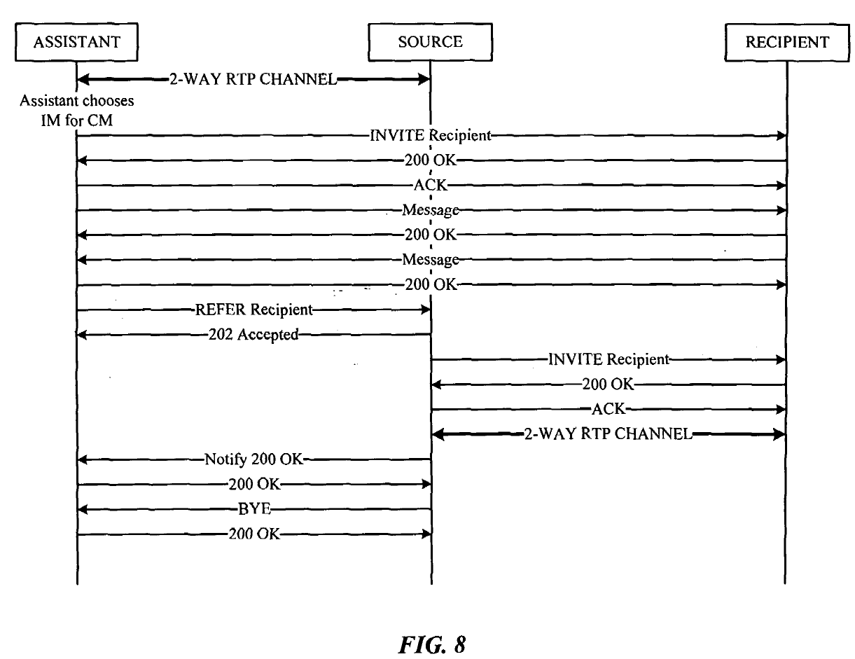

FIG. 8 illustrates an exemplary call flow diagram of an IM interchange as a consultation mode between the assistant user and the recipient. Initially, in a VoIP scenario, a 2-way RTP (realtime transport protocol) channel is opened between the assistant user and the source (or caller). In a typical implementation, SIP sessions are simply packet streams of the RTP-the carrier for the actual voice or video content itself.

SIP a peer-to-peer protocol that requires only a very simple core network with intelligence embedded in endpoints (terminating devices built in either hardware or software). Hardware endpoints that provide the look, feel, and shape of a traditional telephone, can use SIP and RTP for communications, and further, can use Electronic Numbering (ENUM) to translate existing phone numbers into SIP addresses (based on a URL (uniform resource locator) format). Accordingly, calls to other SIP users can bypass the telephone network even though the service provider might normally act as a gateway to the PSTN network for traditional phone numbers and associated charges.

SIP uses network elements called proxy servers to help route requests to the user's current location, authenticate and authorize users for services, implement provider call-routing policies, and provide features to users. SIP also provides a registration function through a registrar (or user agent server) that allows users to upload their current locations for use by proxy servers.

The assistant user then chooses IM as a consultation mode (CM) to the call recipient. A SIP INVITE message is communicated to the recipient. The recipient responds with a SIP 200 OK message. The assistant user acknowledges receipt using a SIP ACK message, and then sends a text message to the recipient. The recipient device responds with a SIP 200 OK message, followed by the recipient response text as to how to handle the call. Given the information needed, the assistant user responds with a 200 OK. If the recipient chooses to speak to the caller, the assistant user refers the recipient to the source (or caller) by giving the caller the recipient SIP address information. The source responds with a SIP 202 ACCEPTED message, after which the source invites the recipient to a session. The recipient responds with a 200 OK, the source acknowledges, and a 2-way RTP channel is opened for communications. The source then signals the assistant with a Notify 200 OK message, the assistant user responds with a 200 OK, and the assistant/source connection is terminated. The source/recipient connection can continue as such time the connection is terminated by either party.

Note that this example indicates an entire IP-based communications transfer and exchange such as associated with a VoIP connection. However, as indicated above, this is not the only implementation of the disclosed non-voice consultation mode innovation. Moreover, the assistant facilitated the source/recipient connection via the IM connection. In other words, the assistant user first consulted with the recipient to get authorization of the connection, contacted the source to pass on the recipient's SIP address, and then departed from of the communication.

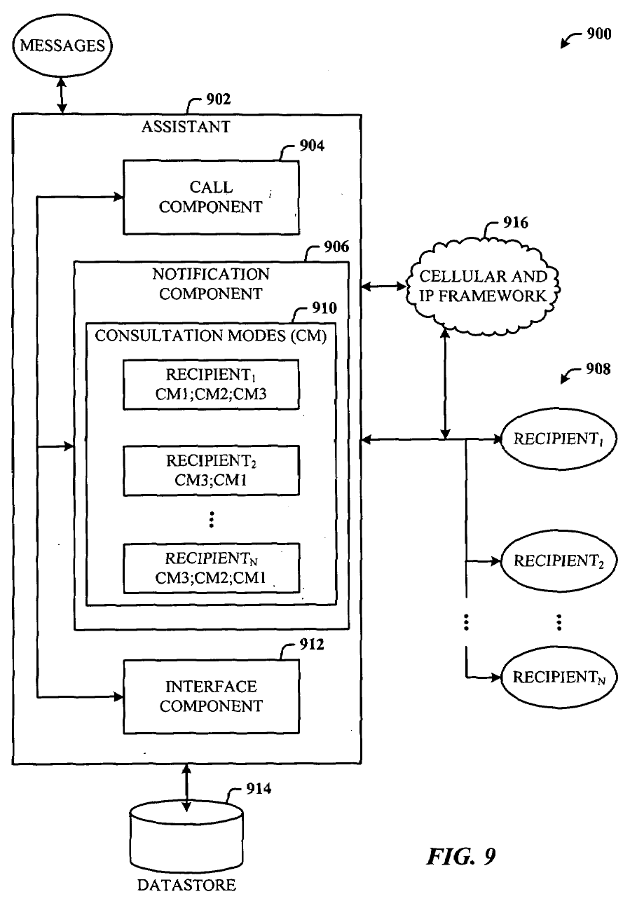

It is within contemplation of the subject architecture that the call assistant can act as a message assistant by not only handling telephone calls, but also incoming messages of disparate types. FIG. 9 illustrates an alternative implementation of a message assistant system 900 that facilitates handling of not only incoming telephone calls but also messages of different types for consultation mode for multiple recipients and message management in accordance with the disclosed innovation. The system 900 can include a message assistant 902 for receiving, processing, and routing messages (e.g., switched circuit calls, IP-based calls, cellular calls, text messages, IM, SMS and MMS). The messages (e.g., IP-based) can be received into a call component 904 for initial processing such as for answering by the assistant 902 and/or packet processing for call information. The call information can include a wide variety of information including, but not limited to, caller identity, originating number of caller, source of message (e.g., device, network), quality of service (QoS) data, and so on.

The assistant 902 can also include a notification component 906 for selecting and utilizing different consultation modes (CM) for consulting with one or more message recipients 908 (denoted RECIPIENT₁, RECIPIENT₂, . . . , RECIPIENT_{N}, where N is a positive integer) about incoming messages and/or message sources. For example, a first received message can be processed for consultation with a first recipient (denoted RECIPIENT₁) while a second received message can be processed for consultation with a second recipient (denoted RECIPIENT₂).

The notification component 906 can include a library 910 of consultation modes developed and assigned for each of the recipients 908. For example, the first recipient (RECIPIENT₁) can have three consultation modes assigned: CM1, CM2, and CM3, where CM1 can represent paging, CM2 can represent SMS, and CM3 can represent IM. Additionally, the first recipient has requested and been assigned by the assistant administrator a priority for handling consultation. Here, the order of priority is to receive consultation first by paging, followed by SMS if paging does not work, and lastly by IM if either of the first two fail to reach the recipient.

Similarly, the second recipient (RECIPIENT₂) can have two consultation modes assigned: CM1 and CM3, where CM1 can represent paging and CM3 can represent IM. The second recipient will receive consultation according to a preferred priority where the order of priority is to receive consultation first by IM, followed by paging if IM fails to reach the recipient. Thus, each recipient can be consulted about incoming messages such as phone calls and messages according to the desired priority and types of consultation.

As before, an interface component 912 facilitates administration of the assistant system 902 for configuring recipient consultation modes, devices, preferences for when and from whom to receive a call or message, etc. For at least IP-based calls, the call component 904 facilitates connecting the caller and recipient according to the preferred communication method requested by the recipient.

The system 900 can also process a single incoming message (e.g., call) to multiple different users such as associated with a conference call. For example, the message source can be a caller requesting to setup a conference call with for two or more of the recipients 908. Thus, the receptionist can utilize the assistant to perform non-voice consultation with the requested recipients concurrently. In other words, the receptionist can input text into the assistant, which text will then be transmitted concurrently to the respective recipients according to their preferred priority methods. More specifically, if the caller requests a conference with the first two recipients, the receptionist can enter text (e.g., “Caller is on the line and wants to initiate a phone conference”). Continuing with the CM priorities in the above example, the assistant 902 will automatically process the text and transmit the text simultaneously to consult with the first and second recipients via paging and IM, respectively. The recipients can respond using any messaging or call technology desired. If both recipients agree to the conference, and both request VoIP, the receptionist can transfer the calls for IP-based conferencing.

It is within the scope of this innovation that where conferencing is involved, the assistant can automatically tally the “votes” for initiating a conference and the methods whereby communications will be conducted, and decide if the conference should go forward, or be scheduled at a later time.

The system 900 can also include a datastore 914 for storing recipient settings such a user preferences, consultation modes, device information, scheduling information, a preferred callers list, and so on, to provide a more efficient and effective consultation user experience.

The assistant 902 can also access major call and/or IP networks 916 such as the PSTN (public switched telephone network), cellular carriers, and the Internet to access device information and caller/recipient information. For example, where VoIP is utilized, the assistant 902 can access caller information for authentication purposes, accounting information and QoS information. The assistant 902 can access Internet websites to download device information to provide the best (or better) method of non-voice consultation, for example.

As indicated supra, the call assistant will typically be used with human interaction such as from a receptionist. However, this is not a requirement. The assistant 902 can be a computer controlled and automated answering and message processing system that automatically answers and consults with the intended recipients 908 according to information stored in the datastore 914 and provided in the notification component 906. This finds particular usage for after-hours operation where the receptionist has left work for the day.

The consultation modes can be automatically adjusted in priority based on other criteria. For example, a first ranking of CMs can be used in the morning (e.g., between 6 AM and noon) where IM is used first, and when the recipient typically is in the office making preparations to go out into the field in the afternoon. At noon, a second set of CMs is accessed based on the recipient being out in the field where, for example, a cell phone will be used, having SMS capabilities, but not IM. Thus, consultation will automatically be processed between the assistant and recipient using SMS. When the user returns to the office, if the user location can be ascertained automatically (e.g., via GPS or online activity), the first set of CMs can be reinstated such that consultation now occurs using IM. These are only but a few examples of the many different capabilities that can be employed for non-voice consultation in accordance with the innovative architecture.

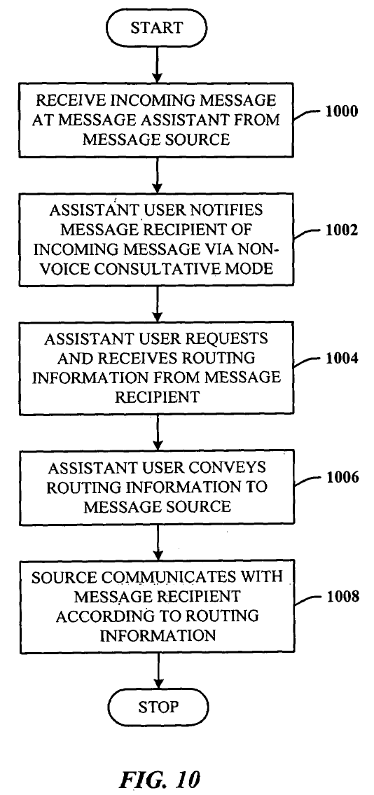

Referring now to FIG. 10, there is illustrated a methodology of managing disparate types of incoming messages for a recipient. Here, the call recipient has arranged with the call assistant to handle not only incoming voice calls, but also non-voice type messages (e.g., IM, SMS, MMS, e-mail, pages). This can be facilitated by the interface component 106 of FIG. 1 by allowing the assistant user to administer the recipient account to route copies or the original messages, for example, from various different types of messaging accounts that the recipient uses. For example, the assistant can receive an e-mail message of the recipient account, the user reads it, and consults with the recipient via another non-voice consultative mode such as IM. This capability can be configured for the many types of messaging that the recipient may employ.

At 1000, the message assistant receives an incoming message from a message source directed to the message recipient. At 1002, the assistant user notifies the recipient of the incoming message using the saine type of messaging or a different type of non-voice consultation mode. At 1004, the assistant user consults with the recipient to request and obtain routing information for routing the incoming message. At 1006, the assistant user notifies the message source to communicate with the recipient according to the routing information. At 1008, the source connects and communicates with the message recipient according to the routing information.

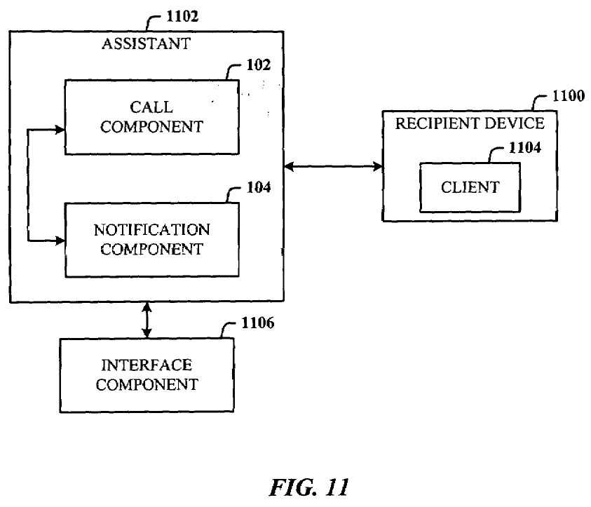

FIG. 11 illustrates that data and signals can be passed between a recipient device 1100 and a call assistant 1102 for determining the best consultation mode to use at a given time. Devices used by callers and call recipients are generally, intelligent devices having an internal processor (or controller) and memory for running local programs of the device and processing data. For example, wired and wireless computers, portable or otherwise, cell phones, and PDAs, are now designed with powerful processing capability to provide onboard features for the consumer. Thus, the device 1100 can include a client 1104 that monitors device and/or network activity, and sends information back to the assistant 1102 that helps the assistant choose the best consultation mode for that recipient device 1100 at that time. The recipient can press a button or make a selection that s/he does not want to be consulted at anytime; This information can be communicated back to the assistant 1102 thereby precluding the receptionist from wasting time attempting to make the consultation. In other words, the recipient can automatically block attempts at consultation.

Additionally, the assistant 1102 with its capabilities and data can be accessed and configured from an external user interface component 1104 (e.g., portable computer, PDA, tablet PC), for access to the call component 102 and notification component 104 of the assistant 1102. Accordingly, the client can be a software component installable on the recipient device 1100 that facilitates this device/assistant communications, control and configuration.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

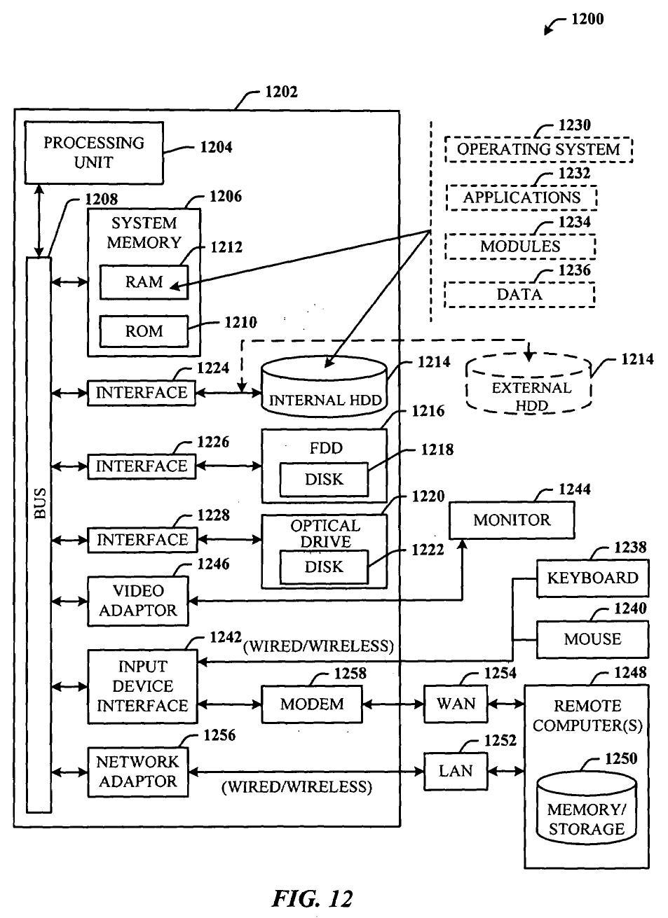

Referring now to FIG. 12, there is illustrated a block diagram of a computing system operable to execute the disclosed assistant and/or consultation architecture. In order to provide additional context for various aspects thereof, FIG. 12 and the following discussion are intended to provide a brief, general description of a suitable computing environment 1200 in which the various aspects of the innovation can be implemented. While the description above is in the general context of computer-executable instructions that may run on one or more computers, those skilled in the art will recognize that the innovation also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the innovation may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 12, the exemplary environment 1200 for implementing various aspects includes a computer 1202, the computer 1202 including a processing unit 1204, a system memory 1206 and a system bus 1208. The system bus 1208 couples system components including, but not limited to, the system memory 1206 to the processing unit 1204. The processing unit 1204 can be any of various commercially available processors. Dual microprocessors and other multi-processor architectures may also be employed as the processing unit 1204.

The system bus 1208 can be any of several types of bus structure that may further interconnect to a memory bus (with or without a memory controller), a peripheral bus, and a local bus using any of a variety of commercially available bus architectures. The system memory 1206 includes read-only memory (ROM) 1210 and random access memory (RAM) 1212. A basic input/output system (BIOS) is stored in a non-volatile memory 1210 such as ROM, EPROM, EEPROM, which BIOS contains the basic routines that help to transfer information between elements within the computer 1202, such as during start-up. The RAM 1212 can also include a high-speed RAM such as static RAM for caching data.

The computer 1202 further includes an internal hard disk drive (HDD) 1214 (e.g., EIDE, SATA), which internal hard disk drive 1214 may also be configured for external use in a suitable chassis (not shown), a magnetic floppy disk drive (FDD) 1216, (e.g., to read from or write to a removable diskette 1218) and an optical disk drive 1220, (e.g., reading a CD-ROM disk 1222 or, to read from or write to other high capacity optical media such as the DVD). The hard disk drive 1214, magnetic disk drive 1216 and optical disk drive 1220 can be connected to the system bus 1208 by a hard disk drive interface 1224, a magnetic disk drive interface 1226 and an optical drive interface 1228, respectively. The interface 1224 for external drive implementations includes at least one or both of Universal Serial Bus (USB) and IEEE 1394 interface technologies. Other external drive connection technologies are within contemplation of the subject innovation.

The drives and their associated computer-readable media provide nonvolatile storage of data, data structures, computer-executable instructions, and so forth. For the computer 1202, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed innovation.

A number of program modules can be stored in the drives and RAM 1212, including an operating system 1230, one or more application programs 1232, other program modules 1234 and program data 1236. All or portions of the operating system, applications, modules, and/or data can also be cached in the RAM 1212. It is to be appreciated that the innovation can be implemented with various commercially available operating systems or combinations of operating systems.

A user can enter commands and information into the computer 1202 through one or more wired/wireless input devices, for example, a keyboard 1238 and a pointing device, such as a mouse 1240. Other input devices (not shown) may include a microphone, an IR remote control, a joystick, a game pad, a stylus pen, touch screen, or the like. These and other input devices are often connected to the processing unit 1204 through an input device interface 1242 that is coupled to the system bus 1208, but can be connected by other interfaces, such as a parallel port, an IEEE 1394 serial port, a game port, a USB port, an IR interface, etc.

A monitor 1244 or other type of display device is also connected to the system bus 1208 via an interface, such as a video adapter 1246. In addition to the monitor 1244, a computer typically includes other peripheral output devices (not shown), such as speakers, printers, etc.

The computer 1202 may operate in a networked environment using logical connections via wired and/or wireless communications to one or more remote computers, such as a remote computer(s) 1248. The remote computer(s) 1248 can be a workstation, a server computer, a router, a personal computer, portable computer, microprocessor-based entertainment appliance, a peer device or other common network node, and typically includes many or all of the elements described relative to the computer 1202, although, for purposes of brevity, only a memory/storage device 1250 is illustrated. The logical connections depicted include wired/wireless connectivity to a local area network (LAN) 1252 and/or larger networks, for example, a wide area network (WAN) 1254. Such LAN and WAN networking environments are commonplace in offices and companies, and facilitate enterprise-wide computer networks, such as intranets, all of which may connect to a global communications network, for example, the Internet.

When used in a LAN networking environment, the computer 1202 is connected to the local network 1252 through a wired and/or wireless communication network interface or adapter 1256. The adaptor 1256 may facilitate wired or wireless communication to the LAN 1252, which may also include a wireless access point disposed thereon for communicating with the wireless adaptor 1256.

When used in a WAN networking environment, the computer 1202 can include a modem 1258, or is connected to a communications server on the WAN 1254, or has other means for establishing communications over the WAN 1254, such as by way of the Internet. The modem 1258, which can be internal or external and a wired or wireless device, is connected to the system bus 1208 via the serial port interface 1242. In a networked environment, program modules depicted relative to the computer 1202, or portions thereof, can be stored in the remote memory/storage device 1250. It will be appreciated that the network connections shown are exemplary and other means of establishing a communications link between the computers can be used.

The computer 1202 is operable to communicate with any wireless devices or entities operatively disposed in wireless communication, for example, a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

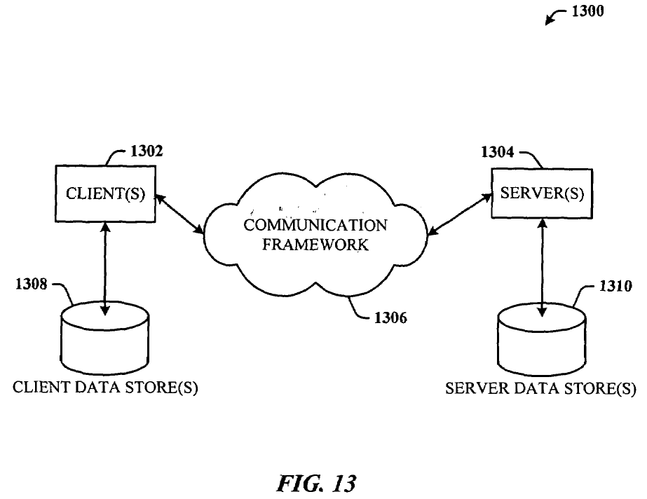

Referring now to FIG. 13, there is illustrated a schematic block diagram of an exemplary computing environment 1300 that facilitates call and message non-voice consultation in accordance with the disclosed consultation architecture. The system 1300 includes one or more client(s) 1302. The client(s) 1302 can be hardware and/or software (e.g., threads, processes, computing devices). The client(s) 1302 can house cookie(s) and/or associated contextual information by employing the subject innovation, for example.

The system 1300 also includes one or more server(s) 1304. The server(s) 1304 can also be hardware and/or software (e.g., threads, processes, computing devices). The servers 1304 can house threads to perform transformations by employing the architecture, for example. One possible communication between a client 1302 and a server 1304 can be in the form of a data packet adapted to be transmitted between two or more computer processes. The data packet may include a cookie and/or associated contextual information, for example. The system 1300 includes a communication framework 1306 (e.g., a global communication network such as the Internet) that can be employed to facilitate communications between the client(s) 1302 and the server(s) 1304.

Communications can be facilitated via a wired (including optical fiber) and/or wireless technology. The client(s) 1302 are operatively connected to one or more client data store(s) 1308 that can be employed to store information local to the client(s) 1302 (e.g., cookie(s) and/or associated contextual information). Similarly, the server(s) 1304 are operatively connected to one or more server data store(s) 1310 that can be employed to store information local to the servers 1304.

What has been described above includes examples of the disclosed innovation. It is, of course, not possible to describe every conceivable combination of components and/or methodologies, but one of ordinary skill in the art may recognize that many further combinations and permutations are possible. Accordingly, the innovation is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computer-implemented system that facilitates call management, comprising:
a call component for receiving a telephone call for a call recipient; and
a notification component for consulting with the call recipient about the call via a non-voice consultation mode.

2. The system of claim 1, wherein the consultation mode is instant messaging.

3. The system of claim 1, wherein the consultation mode is one of a short message service (SMS) and a multimedia messaging service (MMS).

4. The system of claim 1, wherein the consultation mode is one of e-mail and a page.

5. The system of claim 1, wherein the notification component utilizes a session initiation protocol (SIP) for the consultation mode.

6. The system of claim 1, further comprising a user interface component for administering the non-voice consultation mode between the call component and the call recipient.

7. The system of claim 1, further comprising a translation component that translates the call into text output for perception by the call recipient.

8. The system of claim 1, wherein the call component facilitates connecting the caller to the call recipient using a SIP-based consultation mode.

9. A computer-implement&d method of managing communications, comprising acts of:
receiving an incoming message at a message assistant, the incoming message from a message source for communication to a recipient;
notifying the recipient of the incoming message via a non-voice consultation mode;
requesting routing information from the recipient via the non-voice consultation mode; and
communicating the routing information to the message source via the assistant.

10. The method of claim 9, wherein the call assistant is an automated assistant that automatically performs the acts of notifying and routing independent of human interaction.

11. The method of claim 9, wherein the incoming message is a non-voice type message.

12. The method of claim 9, wherein the non-voice consultation mode in the act of notifying is an instant message between the call assistant and the recipient.

13. The method of claim 9, wherein the incoming message in the act of receiving is a telephone call and the non-voice consultation mode in the act of notifying is instant messaging between the call assistant and the recipient.

14. The method of claim 9, wherein the act of notifying is performed when the recipient is on a telephone call.

15. The method of claim 9, wherein the call assistant facilitates sending an instant message to the recipient for the routing information.

16. The method of claim 9, further comprising notifying the recipient via a SIP-based non-voice consultation mode.

17. The method of claim 9, further comprising blocking the consultation mode based on information received from a device client of the recipient.

18. The method of claim 9, further comprising automatically notifying the recipient based on a prioritized list of consultation modes.

19. The method of claim 9, further comprising authenticating the caller prior to the acts of notifying the recipient and requesting routing information.

20. A computer-implemented call consultation system, comprising:
computer-implemented means for receiving call from a caller for a call recipient;
computer-implemented means for authenticating the caller;
computer-implemented means for accessing instant messaging for consulting with the call recipient;
computer-implemented means for requesting call handling information from the recipient via instant messaging; and
computer-implemented means for communicating the call handling information to the caller.
